(19) United States
(12) Patent Application Publication
(10) Pub. No.: US 2026/0279959 A1
(43) Pub. Date: Sep. 17, 2026

(54) Battery Module

(71) Applicant: SK On Co., Ltd., Seoul (KR)

(72) Inventor: Sun Mo AN, Daejeon (KR)

(21) Appl. No.: 19/536,470

(22) Filed: Feb. 11, 2026

(30) Foreign Application Priority Data
Mar. 17, 2025 (KR) 10-2025-0034112

(51) Int. Cl. H01M 10/6556; H01M 10/613; H01M 50/209; H01M 50/502

(52) U.S. Cl. CPC H01M 10/6556; H01M 10/613; H01M 50/209; H01M 50/502

(57) ABSTRACT

A battery module is disclosed. According to an embodiment of the present disclosure, the battery module includes: a plurality of battery cell assemblies sequentially arranged in a transverse direction; and a module case including a bottom module case that accommodates the plurality of battery cell assemblies and is positioned below the plurality of battery cell assemblies, wherein each of the plurality of battery cell assemblies includes: a housing defining a hollow portion open in a longitudinal direction; and a battery cell including a cell body accommodated in the housing and electrode leads protruding from the cell body in the longitudinal direction.

### CROSS-REFERENCE TO RELATED APPLICATION

This patent application claims the priority and benefits of Korean patent application No. 10-2025-0034112, filed on March 17, 2025, the disclosure of which is incorporated herein by reference in its entirety.

### BACKGROUND OF THE INVENTION

### 1. Field of the Invention

The present disclosure relates to a battery module.

### 2. Description of the Related Art

A battery module may include a battery cell and a module case that accommodates the battery cell. If heat is generated from the battery cell and its temperature increases, the function of the battery cell may be degraded, and there may be a risk of fire. As more of the heat generated by the battery cell is transferred to the module case, the thermal stability of the battery module may be improved.

### SUMMARY OF THE INVENTION

According to an aspect of the present disclosure, there is provided a battery module that includes a housing configured to transfer heat generated from a battery cell to a module case.

A battery module according to the present disclosure may include: a plurality of battery cell assemblies sequentially arranged in a transverse direction; and a module case including a bottom module case that accommodates the plurality of battery cell assemblies and is positioned below the plurality of battery cell assemblies, wherein each of the plurality of battery cell assemblies may include: a housing defining a hollow portion open in a longitudinal direction; and a battery cell including a cell body accommodated in the housing and electrode leads protruding from the cell body in the longitudinal direction.

The housing may include: a first housing part that is open in the longitudinal direction and upward and accommodates the battery cell; and a second housing part positioned above the battery cell and coupled to the first housing part.

The housing may further include a housing coupling part configured to couple the first housing part and the second housing part.

The first housing part may include: a bottom housing plate positioned below the battery cell; and a first side housing plate and a second side housing plate each extending upward from the bottom housing plate, wherein the battery cell may be positioned between the first side housing plate and the second side housing plate.

The first side housing plate, the bottom housing plate, and the second side housing plate may be integrally formed.

Each of the plurality of battery cell assemblies may further include a lower heat transfer member positioned between and in contact with the battery cell and the bottom housing plate.

Each of the plurality of battery cell assemblies may further include an upper heat transfer member positioned between and in contact with the battery cell and the second housing part.

The housing may include: a top housing plate positioned above the battery cell; and a first side housing plate and a second side housing plate each extending downward from the top housing plate, wherein the battery cell may be positioned between the first side housing plate and the second side housing plate.

The battery module may further include a lower heat transfer member positioned between and in contact with the battery cell and the bottom module case.

The module case may further include a top module case positioned above the battery cell assembly, wherein the housing may include: a bottom housing plate positioned below the battery cell; and a first side housing plate and a second side housing plate each extending upward from the bottom housing plate, and the battery cell may be positioned between the first side housing plate and the second side housing plate.

The battery module may further include an upper heat transfer member positioned between and in contact with the battery cell and the top module case.

The housing may include: a first housing part including a first side housing plate and a top housing plate connected to an upper end of the first side housing plate and positioned above the battery cell; and a second housing part including a second side housing plate and a bottom housing plate connected to a lower end of the second side housing plate and positioned below the battery cell, wherein the first side housing plate, the battery cell, and the second side housing plate may be sequentially arranged in the transverse direction.

The first side housing plate and the top housing plate may be integrally formed, and the second side housing plate and the bottom housing plate may be integrally formed.

The battery cell may be loaded into the second housing part, and the first housing part may be coupled to the second housing part.

The housing may include: a first housing part including a first side housing plate, a top housing plate connected to an upper end of the first side housing plate and positioned above the battery cell, and a bottom housing plate connected to a lower end of the first side housing plate and positioned below the battery cell; and a second housing part including a second side housing plate, a top housing plate connected to an upper end of the second side housing plate and positioned above the battery cell, and a bottom housing plate connected to a lower end of the second side housing plate and positioned below the battery cell, wherein the first side housing plate, the battery cell, and the second side housing plate may be sequentially arranged in the transverse direction.

The first side housing plate, the top housing plate of the first housing part, and the bottom housing plate of the first housing part may be integrally formed, and the second side housing plate, the top housing plate of the second housing part, and the bottom housing plate of the second housing part may be integrally formed.

The top housing plate of the first housing part and the top housing plate of the second housing part may be coupled while overlapping each other in a vertical direction, and the bottom housing plate of the first housing part and the bottom housing plate of the second housing part may be coupled while overlapping each other in the vertical direction.

Each of the plurality of battery cell assemblies may include: a plurality of battery cells sequentially arranged in the transverse direction as the battery cells; and an inner pad positioned between two adjacent battery cells among the plurality of battery cells.

The inner pad may include: a core inner pad connected to the housing; and a pair of outer inner pads positioned on opposite sides of the core inner pad, wherein each of the pair of outer inner pads may have one surface in contact with the core inner pad and the other surface in contact with a corresponding one of the two battery cells.

The core inner pad may have a lower heat transfer coefficient than a heat transfer coefficient of the housing, and the pair of outer inner pads may be formed of a flexible material.

According to an embodiment of the present disclosure, a battery module may be provided that includes a housing configured to transfer heat generated from a battery cell to a module case.

The battery module of the present disclosure may be used in eco-friendly electric vehicles, hybrid vehicles, and the like, which are intended to mitigate climate change by reducing air pollution and greenhouse gas emissions.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a perspective view illustrating a battery module according to an embodiment of the present disclosure;

FIG. 2 is an exploded perspective view of the battery module illustrated in FIG. 1;

FIG. 3 is a perspective view illustrating a battery cell included in the battery cell assembly illustrated in FIG. 2;

FIG. 4 is a cross-sectional view taken along line B1-B2 of the battery cell illustrated in FIG. 3;

FIG. 5 is a perspective view illustrating the battery cell assembly illustrated in FIG. 2;

FIG. 6 is a cross-sectional view of the battery cell assembly illustrated in FIG. 5 taken along line C1-C2;

FIG. 7 is a cross-sectional view of the battery module illustrated in FIG. 1 taken along line A1-A2;

FIG. 8 is an exploded perspective view of a battery cell assembly including a housing that is open downward according to another embodiment;

FIG. 9 is an exploded perspective view of a battery cell assembly including a housing that is open upward according to another embodiment;

FIG. 10 is an exploded perspective view of a battery cell assembly including a first housing part that is open downward and a second housing part that is open upward according to another embodiment;

FIG. 11 is an exploded perspective view of a battery cell assembly including a first housing part and a second housing part, each provided with a bottom housing plate and a top housing plate, according to another embodiment.

### DETAILED DESCRIPTION OF THE INVENTION

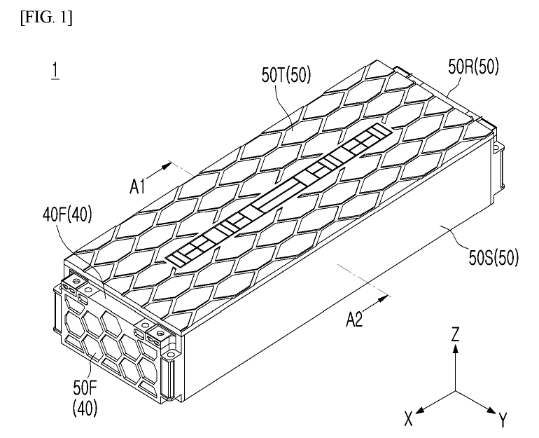

Hereinafter, the present disclosure will be described in detail with reference to FIGS. 1 to 11. However, these are merely illustrative, and the present disclosure is not limited to the specific embodiments described as examples.

An XYZ coordinate system may be used in this specification. The XYZ coordinate system may be a Cartesian coordinate system.

For example, the Z-axis may be parallel to the vertical direction. For instance, a positive Z-axis direction may represent the upward direction, and a negative Z-axis direction may represent the downward direction.

For example, the X-axis may be parallel to the front-rear direction. For instance, a positive X-axis direction may represent the forward direction, and a negative X-axis direction may represent the rearward direction.

For example, the Y-axis may be parallel to the left-right direction. For instance, a positive Y-axis may represent the leftward direction, and a negative Y-axis may represent the rightward direction. For example, a negative Y-axis may refer to “a first side” or “a first direction.” For example, a positive Y-axis may refer to “a second side” or “a second direction.”

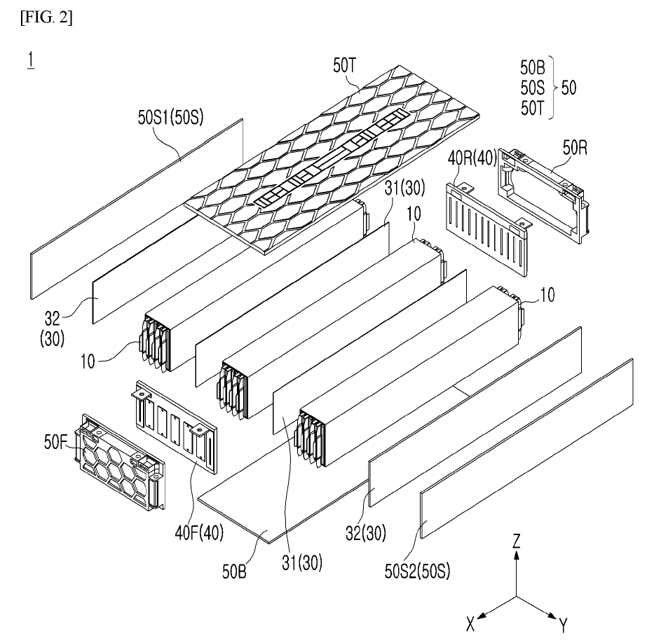

FIG. 1 is a perspective view illustrating a battery module according to an embodiment of the present disclosure. FIG. 2 is an exploded perspective view of the battery module illustrated in FIG. 1.

Referring to FIGS. 1 and 2, a battery module 1 may include a battery cell assembly 10. A plurality of battery cell assemblies 10 may be provided. For example, the battery module 1 may include the plurality of battery cell assemblies 10. The term “module” as used herein is intended to describe a component including a battery cell and/or an assembly of the battery cell-related components, and a battery module does not necessarily denote a subcomponent of a battery pack. Therefore, the battery module described in the present disclosure may also refer to a battery pack or an equivalent component.

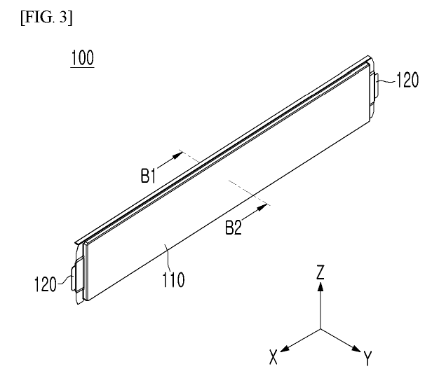

The battery cell assembly 10 may include a battery cell 100 (see FIG. 3). The battery cell 100 (see FIG. 3) may be a secondary battery.

For example, the battery cell 100 (see FIG. 3) may be at least one of a prismatic secondary battery, a cylindrical secondary battery, and a pouch-type secondary battery. For example, the battery cell 100 (see FIG. 3) may be a pouch-type secondary battery.

The battery cell 100 (see FIG. 3) may extend in a lengthwise direction. For example, the lengthwise direction of the battery cell 100 (see FIG. 3) may correspond to a front-rear direction. For example, the lengthwise direction of the battery cell 100 (see FIG. 3) may denote the lengthwise direction of the battery cell assembly 10.

For example, the lengthwise direction of the battery cell assembly 10 may denote the lengthwise direction of the battery module 1. A “longitudinal direction” may denote the lengthwise direction of the battery module 1.

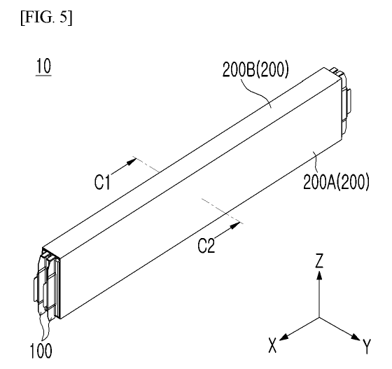

The battery cell assembly 10 may include a housing 200 (see FIG. 5). For example, the housing 200 (see FIG. 5) may accommodate at least one battery cell 100 (see FIG. 5).

The plurality of battery cell assemblies 10 may be sequentially arranged in one direction. For example, the plurality of battery cell assemblies 10 may be sequentially arranged in a transverse direction of the battery module 1. The “transverse direction” may denote the transverse direction of the battery module 1. The longitudinal direction and the transverse direction may define a horizontal plane.

The battery module 1 may include a busbar 40. The busbar 40 may be connected to the battery cell assembly 10. For example, the busbar 40 may electrically connect a plurality of battery cell assemblies 10.

A plurality of busbars 40 may be provided. For example, a battery module 1 may include a front busbar 40F and a rear busbar 40R. The busbar 40 may include or refer to at least one of the front busbar 40F and the rear busbar 40R.

For example, the front busbar 40F may be coupled or connected to a front end portion of the battery cell assembly 10. For example, the rear busbar 40R may be coupled or connected to a rear end portion of the battery cell assembly 10.

The battery module 1 may include a module case 50. The module case 50 may accommodate the battery cell assembly 10. The module case 50 may accommodate at least a portion of the busbar 40.

For example, a portion of the busbar 40 may be exposed rather than accommodated in the module case 50. For example, the portion of the busbar 40 exposed to the outside may include a terminal electrically connected to an external device (not shown).

The module case 50 may include a front module case 50F. The front module case 50F may define a front face of the battery module 1. The front module case 50F may be positioned in front of the battery cell assembly 10. A rear face of the front module case 50F may be disposed to face the front face of the front busbar 40F.

The module case 50 may include a rear module case 50R. The rear module case 50R may define a rear face of the battery module 1. The rear module case 50R may be positioned behind the battery cell assembly 10. A front face of the rear module case 50R may be disposed to face the rear face of the rear busbar 40R.

The module case 50 may include a bottom module case 50B. The bottom module case 50B may define a lower face of the battery module 1. The bottom module case 50B may be positioned below the battery cell assembly 10. For example, the bottom module case 50B may support the battery cell assembly 10.

The module case 50 may include a side module case 50S. The side module case 50S may define a lateral face of the battery module 1.

For example, a first side module case 50S1 may define a first lateral face of the battery module 1. For example, a second side module case 50S2 may define a second lateral face of the battery module 1. The side module case 50S may include or refer to at least one of first side module case 50S1 and second side module case 50S2.

The module case 50 may include a top module case 50T. The top module case 50T may define an upper face of the battery module 1. The top module case 50T may be positioned above the battery cell assembly 10.

For example, the battery cell assembly 10 may be positioned between the bottom module case 50B and the top module case 50T. For example, the battery cell assembly 10 may be positioned between the front module case 50F and the rear module case 50R. For example, the battery cell assembly 10 may be positioned between the first side module case 50S1 and the second side module case 50S2.

For example, the front module case 50F may be connected or coupled to the bottom module case 50B. For example, a bottom end portion of the front module case 50F may be connected or coupled to a front end portion of the bottom module case 50B.

For example, the rear module case 50R may also be connected or coupled to the bottom module case 50B. For example, a bottom end portion of the rear module case 50R may be connected or coupled to a rear end portion of the bottom module case 50B.

For example, a first edge of the bottom module case 50B may extend rearward from a first end of a front end portion of the bottom module case 50B to a first end of a rear end portion of the bottom module case 50B.

For example, a second edge of the bottom module case 50B may extend rearward from a second end of the front end portion of the bottom module case 50B to a second end of the rear end portion of the bottom module case 50B. The second edge of the bottom module case 50B may be positioned opposite the first edge of the bottom module case 50B.

The front end of the bottom module case 50B may extend in the transverse direction from the first end of the front end portion of the bottom module case 50B to the second end of the front end portion of the bottom module case 50B.

The rear end of the bottom module case 50B may extend in the transverse direction from the first end of the rear end portion of the bottom module case 50B to the second end of the rear end portion of the bottom module case 50B.

The front end, first edge, rear end, and second edge of the bottom module case 50B may define a perimeter of the bottom module case 50B. For example, the front end, first edge, rear end, and second edge of the bottom module case 50B may be sequentially connected.

For example, the first side module case 50S1 may be connected or coupled to the bottom module case 50B. For example, a bottom end portion of the first side module case 50S1 may be connected or coupled to the first edge of the bottom module case 50B.

The side module case 50S and the bottom module case 50B may be integrally formed. For example, the side module case 50S may extend upward from the bottom module case 50B.

For example, the first side module case 50S1 may extend upward from the bottom module case 50B. For example, the first side module case 50S1 may extend upward from the first edge of the bottom module case 50B.

For example, the second side module case 50S2 may extend upward from the bottom module case 50B. For example, the second side module case 50S2 may extend upward from the second edge of the bottom module case 50B.

The side module case 50S may be connected or coupled to the front module case 50F. For example, a front end portion of the side module case 50S may be connected or coupled to the front module case 50F.

The side module case 50S may be connected or coupled to the rear module case 50R. For example, a rear end portion of the side module case 50S may be connected or coupled to the rear module case 50R.

The top module case 50T may be coupled to an upper end portion of the side module case 50S. The top module case 50T may be coupled to an upper end portion of the front module case 50F. The top module case 50T may be coupled to an upper end portion of the rear module case 50R.

The battery module 1 may include a middle pad 30. The middle pad 30 may be accommodated in the module case 50. The middle pad 30 may extend in the longitudinal direction. The middle pad 30 may include or refer to at least one of a thermal barrier pad 31 and a surface pressure pad 32.

For example, the battery module 1 may include the thermal barrier pad 31. The thermal barrier pad 31 may be positioned between two adjacent battery cell assemblies 10. The thermal barrier pad 31 may be formed of, for example, a material having a relatively low heat transfer coefficient.

For example, the battery module 1 may include the surface pressure pad 32. The surface pressure pad 32 may be positioned between the battery cell assembly 10 and the side module case 50S.

For example, one of a pair of surface pressure pads 32 may be positioned between the battery cell assembly 10 and the first side module case 50S1, and the other of the pair of surface pressure pads 32 may be positioned between the battery cell assembly 10 and the second side module case 50S2.

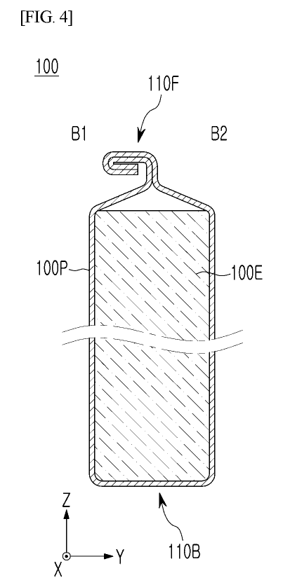

FIG. 3 is a perspective view illustrating the battery cell included in the battery cell assembly illustrated in FIG. 2. FIG. 4 is a cross-sectional view taken along line B1-B2 of the battery cell illustrated in FIG. 3.

Referring to FIGS. 3 and 4, the battery cell 100 may have a longitudinally extending shape. For example, the battery cell 100 may extend in the longitudinal direction from a front end of the battery cell 100 to a rear end of the battery cell 100.

The battery cell 100 may include an electrode assembly 100E. The electrode assembly 100E may store or release electrical energy. The electrode assembly 100E may include a plurality of electrodes.

The battery cell 100 may include a cell case 100P. The cell case 100P may define at least a portion of an outer surface of the battery cell 100. The cell case 100P may accommodate the electrode assembly 100E.

The cell case 100P may be flexible. For example, the cell case 100P may be formed in the shape of a sheet. In this context, the cell case 100P may be referred to as a “pouch.”

The battery cell 100 may include a cell body 110. The cell body 110 may extend in the longitudinal direction. The electrode assembly 100E may constitute a portion of the cell body 110.

The battery cell 100 may include electrode leads 120. The electrode leads 120 may protrude from the cell body 110. For example, the electrode leads 120 may protrude from the cell body 110 in the longitudinal direction.

For example, one of a pair of electrode leads 120 may protrude forward from a front end portion of the cell body 110, and the other of the pair of electrode leads 120 may protrude rearward from a rear end portion of the cell body 110.

The cell body lower face 110B may be the lower face of the cell body 110. A cell body folding part 110F may define an upper end portion of the cell body 110. For example, the cell body folding part 110F may be formed by folding and bending a portion of the cell case 100P.

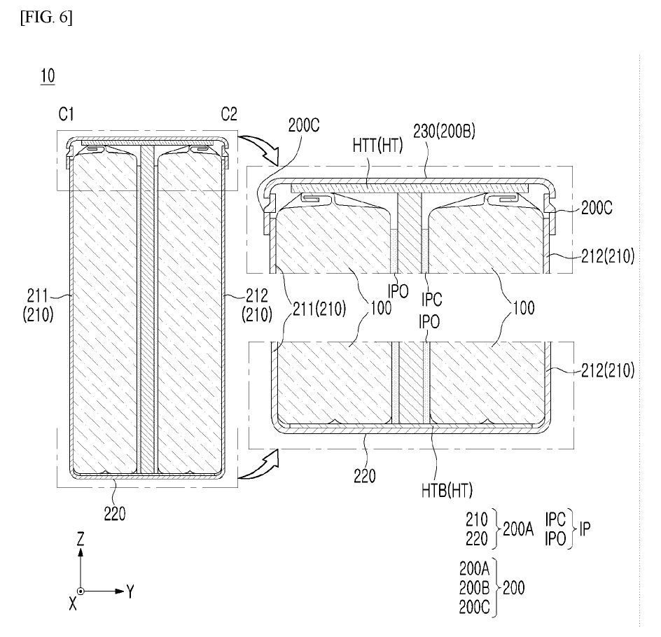

FIG. 5 is a perspective view illustrating the battery cell assembly illustrated in FIG. 2. FIG. 6 is a cross-sectional view of the battery cell assembly illustrated in FIG. 5 taken along line C1-C2.

Referring to FIGS. 5 and 6, the battery cell assembly 10 may include the housing 200. The housing 200 may accommodate at least one battery cell 100. For example, the housing 200 may accommodate a plurality of battery cells 100.

The housing 200 may have a longitudinally extending shape. For example, the lengthwise direction of the housing 200 may denote the longitudinal direction. The housing 200 may define a hollow portion.

For example, the hollow portion defined in the housing 200 may be open in the longitudinal direction. For example, the hollow portion defined in the housing 200 may be open at a front end and a rear end of the housing 200.

For example, the plurality of battery cells 100 may be accommodated in the housing 200 and arranged in the transverse direction. A width direction of the housing 200 may denote the transverse direction. An inner pad IP may be disposed between two adjacent battery cells 100.

For example, the battery cell assembly 10 may include the inner pad IP. For example, the battery cell assembly 10 may include a core inner pad IPC and an outer inner pad IPO. The inner pad IP may include or refer to at least one of the core inner pad IPC and the outer inner pad IPO.

A plurality of outer inner pads IPO may be provided. For example, the core inner pad IPC may be positioned between a pair of outer inner pads IPO.

The outer inner pad IPO may be positioned between the core inner pad IPC and the battery cell 100. For example, one surface of the outer inner pad IPO may be in contact with the core inner pad IPC, and the other surface of the outer inner pad IPO may be in contact with the battery cell 100.

The outer inner pad IPO may be formed of a flexible material. For example, the outer inner pad IPO may be formed of a material including polyurethane.

If the battery cell 100 malfunctions, the battery cell 100 may swell. If the battery cell 100 swells, the outer inner pad IPO may be compressed.

The core inner pad IPC may have a relatively low heat transfer coefficient. For example, the core inner pad IPC may inhibit heat transfer between two adjacent battery cells 100.

For example, the core inner pad IPC may have a lower heat transfer coefficient than that of the housing 200. For example, the heat transfer coefficient of the core inner pad IPC may be lower than that of the outer inner pad IPO.

For example, the core inner pad IPC may be connected to a top housing plate 230 and a bottom housing plate 220. For example, an upper end of the core inner pad IPC may be connected to the top housing plate 230, and a lower end of the core inner pad IPC may be connected to the bottom housing plate 220.

For example, the upper end of the core inner pad IPC may be connected to an upper heat transfer member HTT, which is in contact with a lower face of the top housing plate 230. For example, the lower end of the core inner pad IPC may be connected to a lower heat transfer member HTB, which is in contact with an upper face of the bottom housing plate 220.

For example, two adjacent battery cells 100 accommodated in a single housing 200 may be separated from each other by the core inner pad IPC in the housing 200. In other words, the core inner pad IPC may separate the two adjacent battery cells 100 accommodated in the single housing 200 in terms of heat transfer.

In other words, the core inner pad IPC may function as a firewall. For example, the core inner pad IPC may be formed of a material including mica.

For example, the housing 200 may be composed of a plurality of parts. For example, the housing 200 may include a first housing part 200A and a second housing part 200B.

The first housing part 200A and the second housing part 200B may be coupled to each other. For example, the housing 200 may include a housing coupling part 200C. The housing coupling part 200C may couple the first housing part 200A and the second housing part 200B.

The housing 200 may include the bottom housing plate 220. For example, the first housing part 200A may include the bottom housing plate 220. The bottom housing plate 220 may be positioned beneath the battery cell 100.

The housing 200 may include a side housing plate 210. A plurality of side housing plates 210 may be provided. For example, the housing 200 may include a first side housing plate 211 and a second side housing plate 212.

The side housing plate 210 may include or refer to at least one of the first side housing plate 211 and the second side housing plate 212.

For example, the first side housing plate 211 and the second side housing plate 212 may be arranged in the transverse direction. The battery cell 100 and the inner pad IP may be positioned between the first side housing plate 211 and the second side housing plate 212.

For example, while the inner pad IP and the battery cell 100 are not accommodated in the housing 200, the first side housing plate 211 and the second side housing plate 212 may be disposed to face each other.

The bottom housing plate 220, the first side housing plate 211, and the second side housing plate 212 may be integrally formed. For example, the first housing part 200A may be formed by bending a single metal plate.

The housing 200 may include the top housing plate 230. For example, the second housing part 200B may include the top housing plate 230. The top housing plate 230 may be positioned above the battery cell 100.

The battery cell assembly 10 may include a heat transfer member HT. For example, the battery cell assembly 10 may include the lower heat transfer member HTB. The lower heat transfer member HTB may be positioned between the battery cell 100 and the bottom housing plate 220.

Through the lower heat transfer member HTB, the battery cell 100 may be attached or fixed to the bottom housing plate 220. For example, the lower heat transfer member HTB may be in contact with the bottom housing plate 220 and the cell body lower face 110B (see FIG. 4). The lower heat transfer member HTB may have a relatively high heat transfer coefficient.

For example, the battery cell assembly 10 may include the upper heat transfer member HTT. The upper heat transfer member HTT may be positioned between the battery cell 100 and the top housing plate 230.

The battery cell 100 may be attached or fixed to the top housing plate 230 through the upper heat transfer member HTT. For example, the upper heat transfer member HTT may be in contact with the top housing plate 230 and the cell body folding part 110F (see FIG. 4).

The upper heat transfer member HTT may have a relatively high heat transfer coefficient. For example, the upper heat transfer member HTT and the lower heat transfer member HTB may be formed of the same material. The heat transfer member HT may include or refer to at least one of the upper heat transfer member HTT and the lower heat transfer member HTB.

The housing 200 may be formed of a material having a relatively high heat transfer coefficient. For example, the housing 200 may be formed of a material including a metal. For example, the housing 200 may be formed of a material including aluminum.

For example, heat generated from the battery cell 100 may be transferred to the housing 200. By being formed of a material having a relatively high heat transfer coefficient, the housing 200 may allow heat generated from the battery cell 100 to be effectively dissipated to the outside.

A portion of the heat generated from the battery cell 100 may be transferred to the bottom housing plate 220 through the lower heat transfer member HTB. Another portion of the heat generated from the battery cell 100 may be transferred to the top housing plate 230 through the upper heat transfer member HTT.

A portion of the heat generated from the battery cell 100 may be transferred to the side housing plate 210. A portion of the heat transferred to the side housing plate 210 may be further transferred to the top housing plate 230, and another portion may be transferred to the bottom housing plate 220.

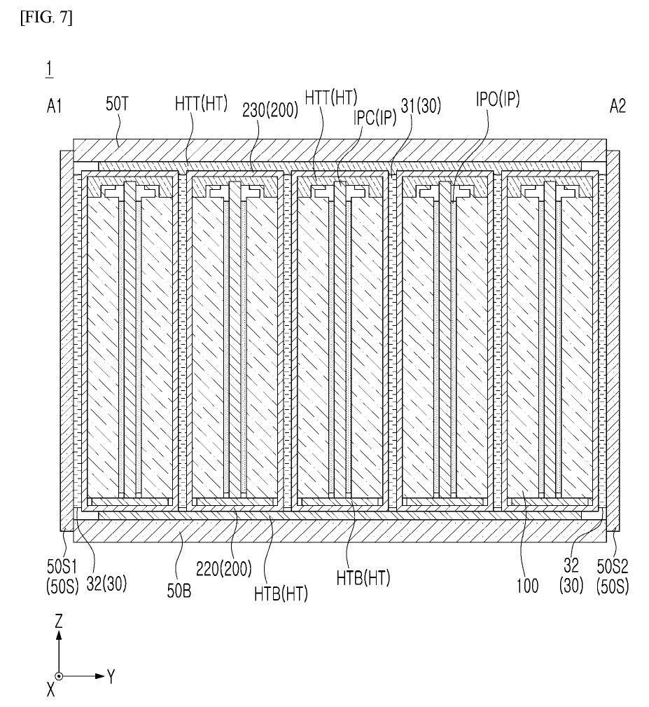

FIG. 7 is a cross-sectional view of the battery module illustrated in FIG. 1 taken along line A1-A2.

Referring to FIGS. 1 to 7, the lower heat transfer member HTB may be positioned between the bottom housing plate 220 and the bottom module case 50B. For example, a portion of the heat generated from the battery cell 100 may be sequentially transferred to the bottom module case 50B through the bottom housing plate 220 and the lower heat transfer member HTB.

The upper heat transfer member HTT may be positioned between the top housing plate 230 and the top module case 50T. For example, at least a portion of the heat generated from the battery cell 100 may be sequentially transferred to the top module case 50T through the top housing plate 230 and the upper heat transfer member HTT.

At least a portion of the heat transferred to the bottom module case 50B and the top module case 50T may be dissipated to the outside through at least one of heat conduction and heat radiation.

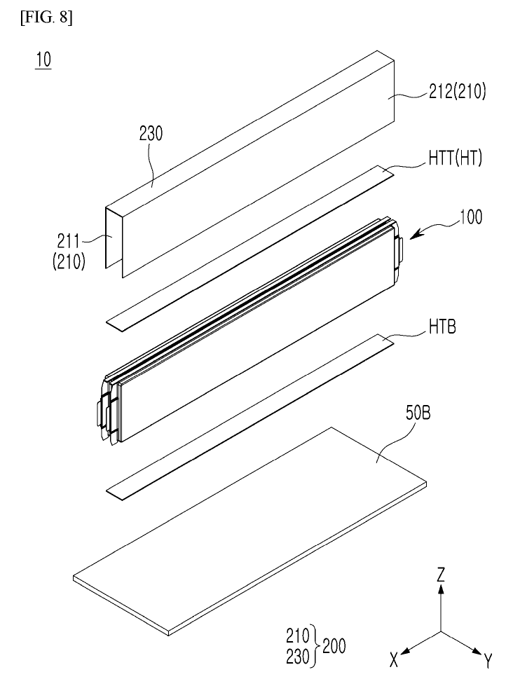

FIG. 8 is an exploded perspective view of a battery cell assembly including a housing that is open downward according to another embodiment.

Referring to FIG. 8, a housing 200 may be open downward. In one embodiment, the housing 200 may include a top housing plate 230 positioned above the battery cell 100, a first side housing plate 211 and a second side housing plate 212 each extending downward from the top housing plate 230. The battery cell 100 may be positioned between the first side housing plate 211 and the second side housing plate 212.

For example, the cell body lower face 110B (see FIG. 4) of the battery cell 100 accommodated in the housing 200 may be disposed to face the bottom module case 50B.

In one embodiment, the battery module 1 may further include a lower heat transfer member HTB positioned between and in contact with the battery cell 100 and the bottom module case 50B.

For example, the lower heat transfer member HTB may be positioned between the cell body lower face 110B of the battery cell 100 and the bottom module case 50B.

For example, an upper face of the lower heat transfer member HTB may be in contact with the cell body lower face 110B, and a lower face of the lower heat transfer member HTB may be in contact with an upper face of the bottom module case 50B.

For example, a portion of the heat generated from the battery cell 100 may be transferred to the lower heat transfer member HTB through the cell body lower face 110B (see FIG. 4), and at least a portion of the heat transferred to the lower heat transfer member HTB may be further transferred to the bottom module case 50B.

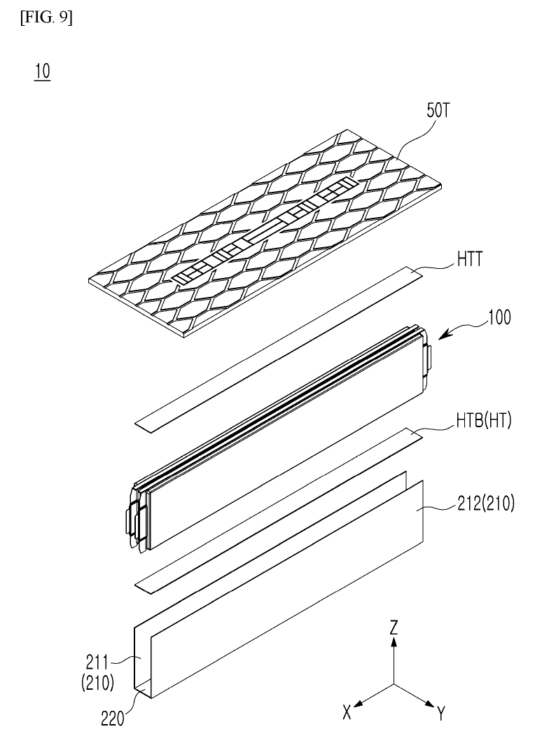

FIG. 9 is an exploded perspective view of a battery cell assembly including a housing that is open upward according to another embodiment.

Referring to FIG. 9, a housing 200 may be open upward. In one embodiment, the housing 200 may include a bottom housing plate 220 positioned below the battery cell 100, a first side housing plate 211 and a second side housing plate 212 each extending upward from the bottom housing plate 220.

The battery cell 100 may be positioned between the first side housing plate 211 and the second side housing plate 212.

A top module case 50T may be positioned above the battery cell assembly 10.

For example, the cell body folding part 110F (see FIG. 4) of the battery cell 100 accommodated in the housing 200 may be disposed to face the top module case 50T.

In one embodiment, the battery module 1 may further include an upper heat transfer member HTT positioned between and in contact with the battery cell 100 and the top module case 50T.

For example, the upper heat transfer member HTT may be positioned between the cell body folding part 110F of the battery cell 100 (see FIG. 4) and the top module case 50T.

For example, a lower face of the upper heat transfer member HTT may be in contact with the cell body folding part 110F, and an upper face of the upper heat transfer member HTT may be in contact with a lower face of the top module case 50T.

For example, a portion of the heat generated from the battery cell 100 may be transferred to the upper heat transfer member HTT through the cell body folding part 110F (see FIG. 4), and at least a portion of the heat transferred to the upper heat transfer member HTT may be further transferred to the top module case 50T.

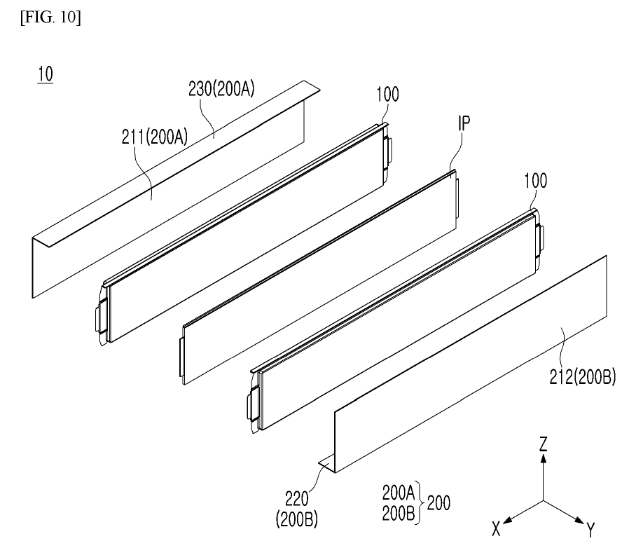

FIG. 10 is an exploded perspective view of a battery cell assembly including a first housing part that is open downward and a second housing part that is open upward according to another embodiment.

Referring to FIG. 10, a first housing part 200A may include a first side housing plate 211 and a top housing plate 230. The first side housing plate 211 and the top housing plate 230 may be integrally formed. For example, the first housing part 200A may be formed by bending a single metal plate.

A second housing part 200B may include a second side housing plate 212 and a bottom housing plate 220. The second side housing plate 212 and the bottom housing plate 220 may be integrally formed. For example, the second housing part 200B may be formed by bending a single metal plate.

The first housing part 200A and the second housing part 200B may be coupled to each other. For example, the housing coupling part 200C (see FIG. 6) may couple the first housing part 200A and the second housing part 200B.

For example, the first side housing plate 211 and the bottom housing plate 220 may be coupled to each other. For example, the second side housing plate 212 and the top housing plate 230 may be coupled to each other.

The battery cell 100 and the inner pad IP may be loaded into the second housing part 200B. Thereafter, the first housing part 200A may be coupled to the second housing part 200B.

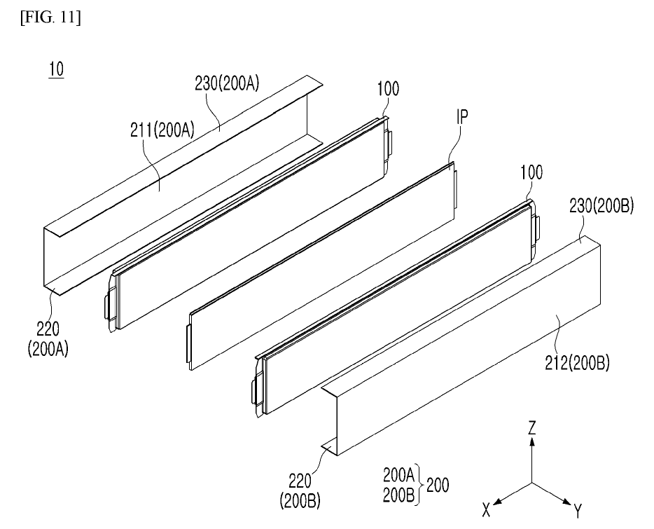

FIG. 11 is an exploded perspective view of a battery cell assembly including a first housing part and a second housing part, each provided with a bottom housing plate and a top housing plate, according to another embodiment.

Referring to FIG. 11, a first housing part 200A may include a first side housing plate 211, a top housing plate 230, and a bottom housing plate 220.

The first side housing plate 211, the top housing plate 230 of the first housing part 200A, and the bottom housing plate 220 of the first housing part 200A may be integrally formed. For example, the first housing part 200A may be formed by bending a single metal plate.

A second housing part 200B may include a second side housing plate 212, a bottom housing plate 220, and a top housing plate 230.

The second side housing plate 212, the bottom housing plate 220 of the second housing part 200B, and the top housing plate 230 of the second housing part 200B may be integrally formed. For example, the second housing part 200B may be formed by bending a single metal plate.

The first housing part 200A and the second housing part 200B may be coupled to each other. For example, the housing coupling part 200C (see FIG. 6) may couple the first housing part 200A and the second housing part 200B.

For example, the bottom housing plate 220 of the first housing part 200A and the bottom housing plate 220 of the second housing part 200B may be coupled while overlapping each other in the vertical direction.

For example, the top housing plate 230 of the first housing part 200A and the top housing plate 230 of the second housing part 200B may be coupled while overlapping each other in the vertical direction.

For example, the battery cell 100 and the inner pad IP may be loaded into the second housing part 200B. Thereafter, the first housing part 200A may be coupled to the second housing part 200B.

For example, the bottom housing plate 220 of the first housing part 200A and the bottom housing plate 220 of the second housing part 200B may be arranged side by side in the transverse direction and coupled to each other.

For example, the top housing plate 230 of the first housing part 200A and the top housing plate 230 of the second housing part 200B may be arranged side by side in the transverse direction and coupled to each other.

For example, some of the plurality of battery cells 100 may be loaded into the first housing part 200A, and others of the plurality of battery cells 100 may be loaded into the second housing part 200B. Thereafter, the first housing part 200A and the second housing part 200B may be coupled to each other.

The contents described above are merely examples of applying the principles of the present disclosure, and other configurations may be further included without departing from the scope of the present disclosure.

What is claimed is:

1. A battery module comprising:
a plurality of battery cell assemblies sequentially arranged in a transverse direction; and
a module case comprising a bottom module case that accommodates the plurality of battery cell assemblies and is disposed below the plurality of battery cell assemblies,
wherein each of the plurality of battery cell assemblies comprises:
a housing defining a hollow portion open in a longitudinal direction; and
at least one battery cell comprising a cell body accommodated in the housing and electrode leads protruding from the cell body in the longitudinal direction.

2. The battery module according to claim 1, wherein the housing comprises:
a first housing part that is open in the longitudinal direction and upward and accommodates the at least one battery cell; and
a second housing part disposed above the at least one battery cell and coupled to the first housing part.

3. The battery module according to claim 2, wherein the housing further comprises a housing coupling part configured to couple the first housing part and the second housing part.

4. The battery module according to claim 2, wherein the first housing part comprises:
a bottom housing plate positioned below the at least one battery cell; and
a first side housing plate and a second side housing plate each extending upward from the bottom housing plate,
wherein the at least one battery cell is disposed between the first side housing plate and the second side housing plate.

5. The battery module according to claim 4, wherein the first side housing plate, the bottom housing plate, and the second side housing plate are integrally formed.

6. The battery module according to claim 4, wherein each of the plurality of battery cell assemblies further comprises a lower heat transfer member disposed between and in contact with the at least one battery cell and the bottom housing plate.

7. The battery module according to claim 6, wherein each of the plurality of battery cell assemblies further comprises an upper heat transfer member disposed between and in contact with the at least one battery cell and the second housing part.

8. The battery module according to claim 1, wherein the housing comprises:
a top housing plate disposed above the at least one battery cell; and
a first side housing plate and a second side housing plate each extending downward from the top housing plate,
wherein the at least one battery cell is disposed between the first side housing plate and the second side housing plate.

9. The battery module according to claim 8, further comprising a lower heat transfer member disposed between and in contact with the at least one battery cell and the bottom module case.

10. The battery module according to claim 1, wherein the module case further comprises a top module case disposed above the at least one battery cell assembly,
wherein the housing comprises:
a bottom housing plate disposed below the at least one battery cell; and
a first side housing plate and a second side housing plate each extending upward from the bottom housing plate,
wherein the at least one battery cell is disposed between the first side housing plate and the second side housing plate.

11. The battery module according to claim 10, wherein the at least one battery cell includes a plurality of battery cells, and
the battery module further comprises an upper heat transfer member disposed between and in contact with at least one of the plurality of battery cells and the top module case.

12. The battery module according to claim 1, wherein the housing comprises:
a first housing part comprising a first side housing plate and a top housing plate connected to an upper end of the first side housing plate and disposed above the at least one battery cell; and
a second housing part including a second side housing plate and a bottom housing plate connected to a lower end of the second side housing plate and disposed below the at least one battery cell,
wherein the first side housing plate, the at least one battery cell, and the second side housing plate are sequentially arranged in the transverse direction.

13. The battery module according to claim 12, wherein the first side housing plate and the top housing plate are integrally formed, and
the second side housing plate and the bottom housing plate are integrally formed.

14. The battery module according to claim 13, wherein the at least one battery cell is loaded into the second housing part, and
the first housing part is coupled to the second housing part.

15. The battery module according to claim 1, wherein the housing comprises:
a first housing part comprising a first side housing plate, a top housing plate connected to an upper end of the first side housing plate and disposed above the at least one battery cell, and a bottom housing plate connected to a lower end of the first side housing plate and disposed below the at least one battery cell; and
a second housing part comprising a second side housing plate, a top housing plate connected to an upper end of the second side housing plate and disposed above the at least one battery cell, and a bottom housing plate connected to a lower end of the second side housing plate and disposed below the at least one battery cell,
wherein the first side housing plate, the at least one battery cell, and the second side housing plate are sequentially arranged in the transverse direction.

16. The battery module according to claim 15, wherein the first side housing plate, the top housing plate of the first housing part, and the bottom housing plate of the first housing part are integrally formed, and
the second side housing plate, the top housing plate of the second housing part, and the bottom housing plate of the second housing part are integrally formed.

17. The battery module according to claim 16, wherein the top housing plate of the first housing part and the top housing plate of the second housing part are coupled while overlapping each other in a vertical direction, and
the bottom housing plate of the first housing part and the bottom housing plate of the second housing part are coupled while overlapping each other in the vertical direction.

18. The battery module according to claim 1, wherein each of the plurality of battery cell assemblies comprises:
a plurality of battery cells sequentially arranged in the transverse direction as the battery cells; and
an inner pad disposed between two adjacent battery cells among the plurality of battery cells.

19. The battery module according to claim 18, wherein the inner pad comprises:
a core inner pad connected to the housing; and
a pair of outer inner pads disposed on opposite sides of the core inner pad,
wherein each of the pair of outer inner pads has one surface in contact with the core inner pad and the other surface in contact with a corresponding one of the two battery cells.

20. The battery module according to claim 19, wherein the core inner pad has a lower heat transfer coefficient than a heat transfer coefficient of the housing, and
the pair of outer inner pads are formed of a flexible material.
